(19) United States
(12) Patent Application Publication
(10) Pub. No.: US 2005/0196218 A1
(43) Pub. Date: Sep. 8, 2005

(54) Printer

(75) Inventors: Heinz-Josef Hautvast, Brigachtal (DE); Thomas Riester, Villingen-Schwenningen (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/086,456

(22) Filed: Mar. 23, 2005

Related U.S. Application Data
(63) Continuation of application No. PCT/DE03/02751, filed on Aug. 18, 2003.

(30) Foreign Application Priority Data
Sep. 11, 2002 (DE) 102 42 474.8
Feb. 11, 2003 (DE) 103 05 634.3

(51) Int. Cl. B41J 29/12

(52) U.S. Cl. 400/693; 400/691

(57) ABSTRACT

The invention relates to a printer having a paper transporting cylinder and a housing provided with a panel having a paper output slit. The printer also has a device for protecting against the penetration of dust and spray water. According to the invention, the device includes a wedge which, in a first position, closes the paper output slit when the printer is not in use, and, in a second position, opens the paper output slit when the printer is in use in such a way that paper can pass through the paper output slit. The invention also has a drive for displacing the closing wedge from the first position to the second position and back.

The invention relates to a printer having a paper transporting roll and a housing having a front panel with a paper outlet slot. Printers of this type are used, for example, in motor vehicles in order to be able to output in paper form values stored in tachographs. Particularly in utility vehicles, because of the environmental conditions which occur therein, it is necessary to provide a device to protect against the penetration of dust and spray water. From the prior art, it is known to cover the printer completely or, when the printer is installed in a dashboard, to cover a corresponding front panel completely with a protective cap. In order to print out values, this cap either has to be removed by hand or moved away by a complicated mechanism.

It is an object of the invention to specify a device which is constructed simply, with which the penetration of dust and spray water can be prevented and which requires no additional activities on the part of the user of the printer. This object is achieved in that the device has a wedge which, in a first position, closes the paper outlet slot when the printer is not being used and, in a second position, when the printer is being used, opens the paper outlet slot in such a way that paper can pass through the paper outlet slot, and in that there is a drive for moving the closure wedge from the first into the second position and back.

It is an advantage in this case that, when it is in the second position, the closure wedge is simultaneously present to guide the paper, since the paper is not folded by the wedge shape. Furthermore, the wedge can form a tear-off edge for the paper.

The fact that the wedge tapers in the direction of the inner side of the printer housing means that a particularly flat front panel surface can be implemented in the first position and, at the same time, in the second position the tear-off edge for the paper can be located on the outside, since, in such a configuration, the wedge has to be moved outward from the first to the second position.

The fact that the wedge has an extension which extends into the housing means that the wedge can be moved simply from inside the housing.

The fact that the extension is connected to the paper transporting roll via a clutch means that no separate drive motor is required for the movement of the wedge.

A frictional clutch can be used particularly simply.

It is also possible to provide a toothed mechanism, such as a rack on the extension and a gear on the paper transporting roll, with an additional clutch, in order to be able to switch off the drive when the second position is reached.

The construction of the device is particularly simple if the wedge can be pivoted about an axis of rotation during the movement between the two positions. It is also possible to move the wedge between the two positions by means of a carriage.

The invention will be explained in more detail below by using the figures for a particularly preferred exemplary embodiment, in which:

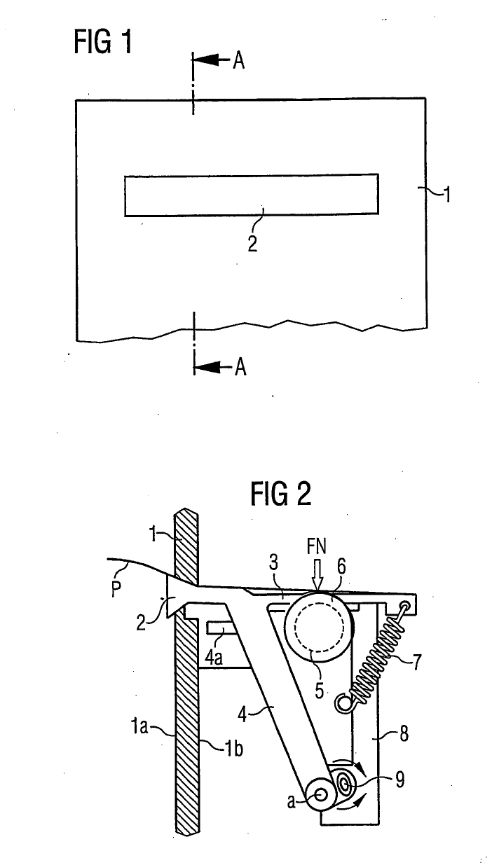

FIG. 1 shows the view of a front panel having a closure wedge,

FIG. 2 shows the section A-A through FIG. 1 with the closure wedge in a first position,

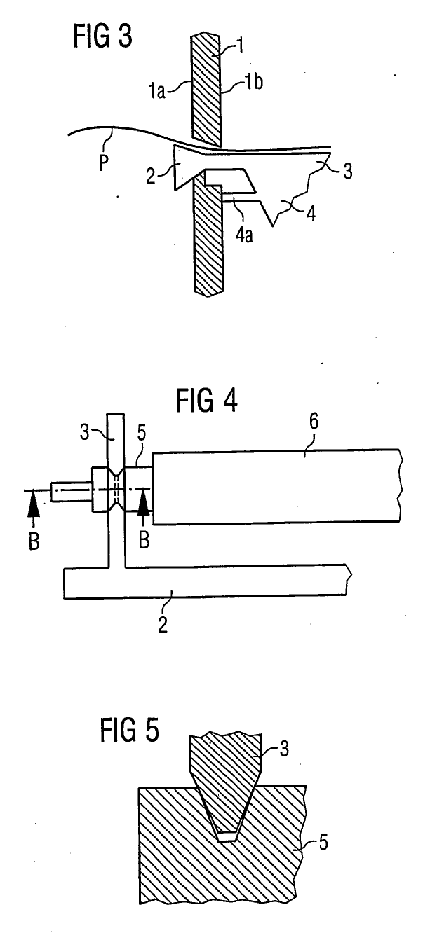

FIG. 3 shows a part of the section from FIG. 2 with the closure wedge in a second position,

FIG. 4 shows the bottom view of the closure wedge from FIG. 2 with a paper transporting roll,

FIG. 5 shows a part of the section B-B from FIG. 4.

In FIG. 1 it is possible to see a front panel 1 and a closure wedge 2, which closes a paper outlet slot that is not visible in FIG. 1.

FIG. 2 shows the closure wedge 3 in the front panel 1 in a first, closed position. The front panel 1 has an outer housing side 1a and an inner housing side 1b. The closure wedge 2 tapers in the direction of the inner housing side 1b and continues in an extension 3 and a lever 4 having a stop 4a. Furthermore, FIG. 2 shows a drive roll 5, a paper transporting roll 6, a spring element 7, paper P and a printer module 8 having a paper roll 9. An axis of rotation a of the lever 4 and therefore also of the closure wedge 2 is located below the drive roll 5. The spring element 6 presses the extension 3 onto the drive roll 5. The paper P is clamped in between the closure wedge 2 and the front panel 1. In this way, the paper outlet slot is sealed off against dust and spray water.

In FIG. 3, the closure wedge 2 is in its second position, so that the paper outlet slot is partly opened and the paper P can pass unimpeded through the paper outlet slot.

In FIG. 4 it can be seen that the paper transporting roll 6 and the drive roll 5 are connected coaxially to each other and the interaction between the extension 7 and the drive roll 5 is configured as a friction clutch. For this purpose, the extension 3 has a wedge-shaped configuration in its lower region, which engages in a wedge-shaped groove in the drive shaft 5 (see FIG. 5).

The spring element 5 presses the extension 3 onto the drive roll 5. When the paper is advanced, the paper P is moved by the rotational movement of the paper transporting roll 6. Furthermore, the drive roll 5 moves the closure wedge 2 via the extension 3 and in this way opens the paper outlet slot. The required frictional force between the extension 3 and the drive roll 5 can be chosen appropriately via the roll profile and the pulling force of the spring element 6.

The connection between the extension 3 and the drive shaft 5 serves at the same time as a slipping clutch when the second position, illustrated in FIG. 2, is reached and the stop 4a is resting on the inner side 1b of the front panel 1.

The paper outlet slot is closed by the rotational movement of the paper transporting roll 6 and therefore of the drive roll 5 being reversed and being driven until the closure wedge is 2 is resting on the front panel 1 and closes the paper outlet slot completely, and the paper outlet slot is thus protected against dust and spray water.

1. A printer comprising:
a paper transporting roll,
a housing having a front panel with a paper outlet slot,
a device arranged to protect against penetration of dust and spray water into the front panel, the device comprising a wedge which, in a first position, closes the paper outlet slot when the printer is not being used and, in a second position, when the printer is being used, opens the paper outlet slot such that paper can pass through the paper outlet slot, and
a drive arranged for moving the closure wedge from the first into the second position and back.

2. The printer according to claim 1, wherein the housing further comprises and an inner side and in that the wedge tapers in the direction of the inner side.

3. The printer according to claim 1, wherein the wedge further comprises an extension which extends into the housing.

4. The printer according to claim 3, wherein the extension is arranged to be connected to the paper transporting roll via a clutch.

5. The printer according to claim 4, wherein the clutch is provided by friction.

6. The printer according to claim 4, wherein the drive is provided via a toothed mechanism which, when the second position is reached, is disengaged by means of a clutch.

7. The printer according to claim 3 wherein the wedge is arranged such that it can be rotated about an axis of rotation in order to change its position from the first position to the second position.

8. The printer according to claim 3 wherein the wedge is arranged so as to be displaced from the first into the second position by means of a carriage.

9. The printer according to claim 1, wherein a speed of the wedge during movement from the first position to the second position corresponds to the speed of the paper.
